(19) United States
(12) Patent Application Publication
(10) Pub. No.: US 2009/0299955 A1
(43) Pub. Date: Dec. 3, 2009

(54) Model Based Data Warehousing and Analytics

(75) Inventors: Vijaykumar K. Aski, Bellevue, WA (US); Michael Theodore Roth, Seattle, WA (US); Sandeep M. Phadke, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/129,667

(22) Filed: May 29, 2008

(51) Int. Cl. G06F 17/30

(52) U.S. Cl. 707/2; 707/E17.001

(57) ABSTRACT

Aspects of the subject matter described herein relate to data warehouses. In aspects, mapping information is received that maps elements of a data warehouse to types of a type system. A type system defines a hierarchy of data types of data in a data source from which the data warehouse obtains data. The mapping information also indicates whether subtypes of the data are mapped to the elements. Using this mapping information, the elements of the data warehouse may be automatically created, maintained, and populated. When the type system is changed, mapped elements in the data warehouse may be updated or created and code to extract and load the data from a data source associated with the type system may be created based on the mapping information. In addition, reports based on the mapped elements may continue to work without change.

### BACKGROUND

A data warehouse stores data that is used for reporting and analysis. This data may be collected from various data sources and placed in the data warehouse. In collecting the data, manual, semi-automatic, and automatic mechanisms may be used. For example, a script may execute periodically to obtain information from a data source to place in the data warehouse. As another example, periodically, an employee may copy data from a company database to the data warehouse.

A data warehouse may have storage elements that correspond to aspects an organization cares about. For example, a data warehouse may have a table in which employee information from data sources may be stored. As another example, a data warehouse may have a table in which sales information may be stored.

When the structure of a data source changes, ensuring that data associated with the change is collected and stored in the data warehouse is problematic. For example, if an employee database adds a supervisor employee type, collecting supervisor employee information, placing it in the data warehouse, and reporting on this information may involve vigilance in watching for changes to the employee database and coding to ensure that this information is collected, stored, and made available at the data warehouse.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Briefly, aspects of the subject matter described herein relate to data warehouses. In aspects, mapping information is received that maps elements of a data warehouse to types of a type system. A type system defines a hierarchy of data types of data in a data source from which the data warehouse obtains data. The mapping information also indicates whether subtypes of the data are mapped to the elements. Using this mapping information, the elements of the data warehouse may be automatically created, maintained, and populated. When the type system is changed, mapped elements in the data warehouse may be updated or created and code to extract and load the data from a data source associated with the type system may be created based on the mapping information. In addition, reports based on the mapped elements may continue to work without change.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” is to be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a block diagram representing an exemplary general-purpose computing environment into which aspects of the subject matter described herein may be incorporated;

FIG. 2 is a block diagram representing an exemplary environment in which aspects of the subject matter described herein may be implemented;

FIG. 3 is a block diagram that generally represents a portion of an exemplary type system in accordance with aspects of the subject matter described herein; and

FIG. 4 is a block diagram that generally represents a schema of an exemplary data warehouse in accordance with aspects of the subject matter described herein;

FIG. 5 is a block diagram that generally represents a mapping that associates elements of a type system with elements of a data warehouse model in accordance with aspects of the subject matter described herein;

FIG. 6 is a block diagram that represents components of an exemplary system configured in accordance with aspects of the subject matter described herein;

FIG. 7 is a flow diagram that generally represents exemplary actions that may occur to obtain data from various data sources in accordance with aspects of the subject matter described herein; and

FIG. 8 is a flow diagram that generally represents actions that may occur in receiving and creating mapping information in according with aspects of the subject matter described herein.

### DETAILED DESCRIPTION

### Exemplary Operating Environment

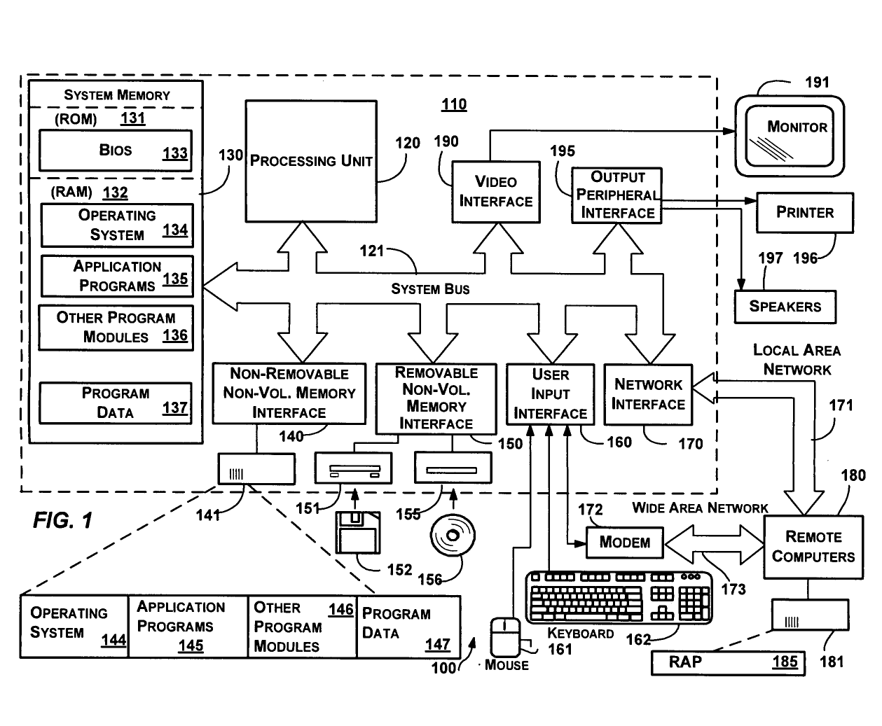

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, Peripheral Component Interconnect Extended (PCI-X) bus, Advanced Graphics Port (AGP), and PCI express (PCIe).

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media.

Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include, but are not limited to, magnetic tape cassettes, flash memory cards, digital versatile discs, other optical discs, digital video tape, solid state RAM, solid state ROM, and the like. The hard disk drive 141 is typically connected to the system bus 121 through a non-removable memory interface such as interface 140, and magnetic disk drive 151 and optical disc drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 20 through input devices such as a keyboard 162 and pointing device 161, commonly referred to as a mouse, trackball, or touch pad. Other input devices (not shown) may include a microphone, joystick, game pad, satellite dish, scanner, a touch-sensitive screen, a writing tablet, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets, and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Data Warehousing

As mentioned previously, when a data source that is associated with a data warehouse changes, data corresponding to this change may not be captured by the data warehouse without re-working the system.

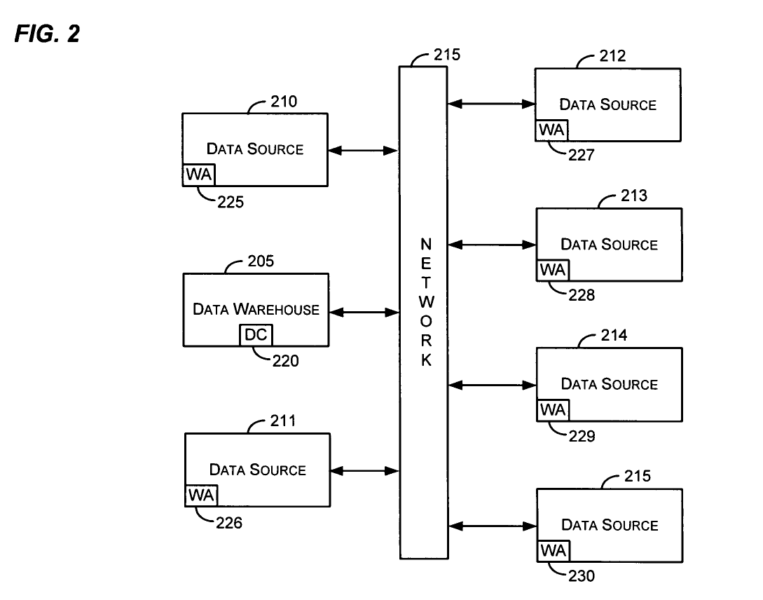

FIG. 2 is a block diagram representing an exemplary environment in which aspects of the subject matter described herein may be implemented. The environment may include a data warehouse 205 and data sources 210-215 and may include other entities (not shown). The various entities may be located relatively close to each other or may be distributed across the world. The various entities may communicate with each other via various networks including intra- and inter-office networks and the network 215.

The data warehouse 205 may include a data store that is capable of storing data in a structured format. The term data is to be read broadly to include anything that may be stored on a computer storage medium. Some examples of data include information, program code, program state, program data, other data, and the like.

A data store may comprise any storage media capable of storing data. For example, a data store may comprise a file system, volatile memory such as RAM, other storage media described in conjunction with FIG. 1, other storage, some combination of the above, and the like and may be distributed across multiple devices. The data store may be external, internal, or include components that are both internal and external to a device hosting the data warehouse 205.

Data stored in the data warehouse 205 may be organized in tables, records, objects, other data structures, and the like. The data may be stored in HTML files, XML files, spreadsheets, flat files, document files, and other files. The data warehouse 205 may comprise a relational database, object-oriented database, hierarchical database, network database, other type of database, some combination or extension of the above, and the like.

Data from a data warehouse 205 may be accessed via a database management system (DBMS). A DBMS may comprise one or more programs that control organization, storage, management, and retrieval of data of the data warehouse 205. A DBMS may receive requests to access data in the data warehouse and may perform the operations needed to provide this access. Access as used herein may include reading data, writing data, deleting data, updating data, a combination including one or more of the above, and the like.

The data warehouse 205 may be implemented on or as one or more computers (e.g., the computer 110 as described in conjunction with FIG. 1). The data warehouse 205 may include a data collector 220. The data collector 220 may work in conjunction with warehouse agents 225-230 to collect data from the data sources 210-215, respectively.

Each of the data sources 210-215 may be implemented on or as one or more computers (e.g., the computer 110 as described in conjunction with FIG. 1). A data source may comprise one or more processes that produce and/or provide data. For example, a data source may comprise a company database. As another example, a data source may comprise an online transaction processing (OLTP) system.

The warehouse agent of a data source may comprise a set of one or more processes, threads, or the like that provide information from the data source to the data warehouse. A warehouse agent may execute periodically, in response to changes of data in the data source, or in some other manner. For example, a warehouse agent may be invoked from a process that updates, deletes, or adds data on a data source. In conjunction with updating, deleting, or adding the data, the warehouse agent may send data to the data warehouse 205.

A data source may include data that is structured according to a type system. In a type system, a type may either be a base type or may derive and extend from another type. For example, a supervisor type may derive from an employee type which may derive from an entity type. A supervisor type may include all the properties of an employee type and may extend these properties with additional properties. Likewise, an employee type may include all the properties of an entity type and may extend these properties. The entity type may be a base type that does not derive from another type.

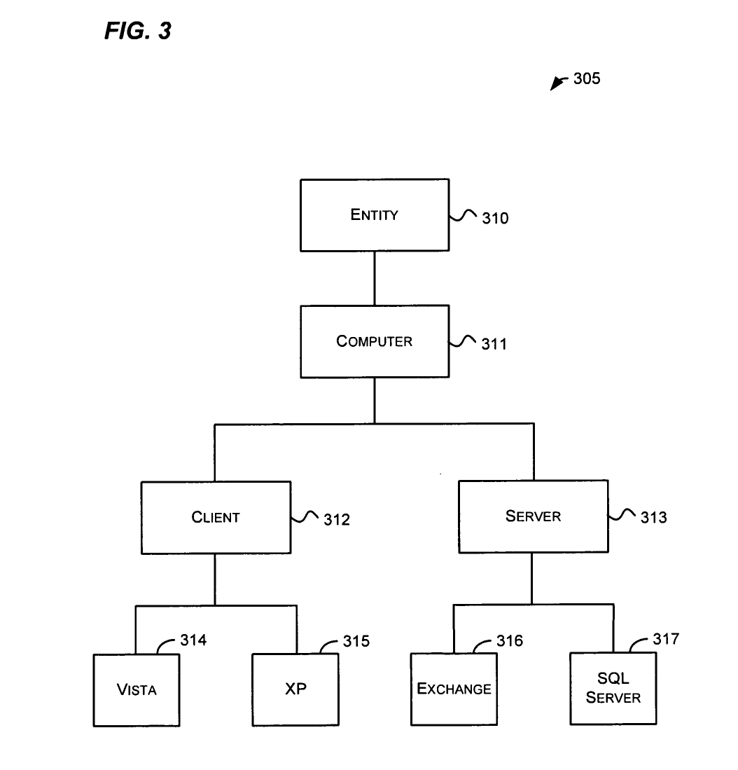

FIG. 3 is a block diagram that generally represents a portion of an exemplary type system in accordance with aspects of the subject matter described herein. The type system 305 may include a Vista type 314 and an XP type 315 that are derived from a client type 312. An exchange type 316 and an SQL server type 317 may derive from a server type 313, while the client type 312 and the server type 313 may derive from a computer type 311. The computer type 311 may derive from the entity type 310. Other types (not shown) may also be part of the type system 305.

In an example, when a data source is first implemented, it may be implemented according to a portion of the type system 305. For example, a data source may be implemented with the entity type 310 and the computer type 311 but without any of the types that derive from the computer type 311. A warehousing agent may be implemented to extract and send data from the data source to a data warehouse based on this implemented type system.

Later, as needs dictate, the data source may be extended to include the other types 312-317. Because it was created for the original data type, the warehousing agent may not capture all or a portion of the data in the other types. It is when this occurs that traditional data warehousing systems lose effectiveness in capturing, storing, and reporting on additional data corresponding to the additional types.

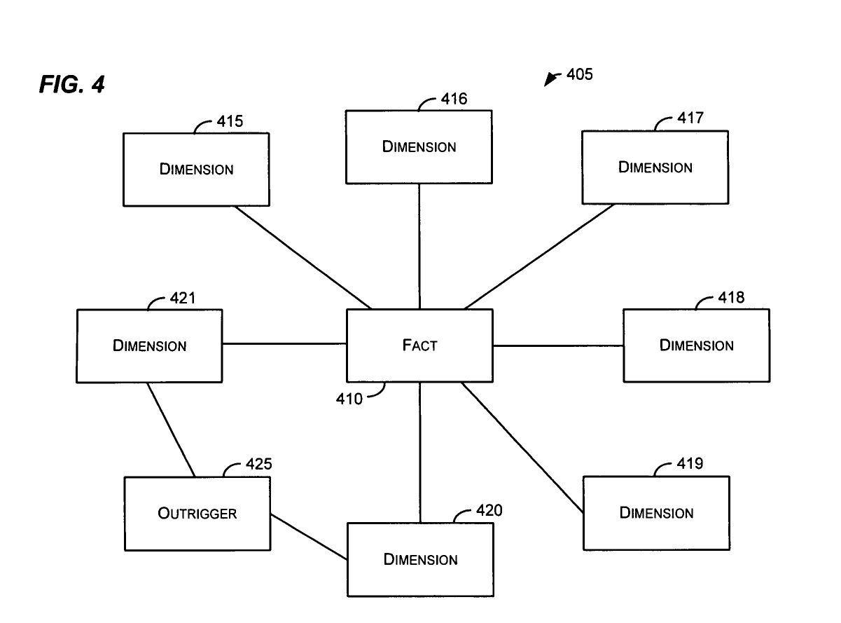

FIG. 4 is a block diagram that generally represents a schema of an exemplary data warehouse in accordance with aspects of the subject matter described herein. The schema includes a fact type 410, dimension types 415-421, and an outrigger type 425.

A dimension captures an aspect of an organization. For example, an organization may have employees having various responsibilities such as engineering, accounting, management, and so forth. To capture information about employees of any responsibility, a dimension may be created in a data warehouse.

As another example, an organization may have products, stores, orders, and salespersons. Each of these general types may have multiple subtypes, but the organization may desire reports on the general level. To capture information from each of these types and their subtypes, if any, four dimensions may be created at a data warehouse.

As used herein, a subtype is any type that derives directly or indirectly from another type. The subtypes of a type are all types that derive directly or indirectly from the type. Referring to FIG. 3, the client type 312 is a subtype of the computer type 311 and of the entity type 310. Similarly, the exchange type 316 is a subtype of the server type 313, the computer type 311, and the entity type 310. Furthermore, the subtypes of the computer type 311 are the types 312-317.

Returning to FIG. 4, a fact associates dimensions. A fact type 410 may be used to create a fact table where each row of the fact table associates corresponding rows of dimension tables. For example, a fact table may include keys that may be used to reference specific rows of the dimension tables defined according to the dimension types 415-421. As an example, a row of the fact table may include keys of a salesperson, a store, a customer, and a product. The salesperson may be an employee of the store and may have sold the customer the product. Information about the salesperson, store, customer, and product may be stored in various dimension tables.

A fact may include zero or more measures. A measure may include additional information about data stored in the one or more dimensions associated by the fact. For example, a measure may include quantity of a product sold in a transaction, CPU or other utilization of a computer, number of software products installed on a computer, price, another measure, or the like.

An outrigger (e.g., an outrigger defined according to the outrigger type 425) associates properties of one or more types (e.g., types associated with the dimensions 420 and 421). For example, one type may include computer information. Computers may be manufactured by various manufacturers. Another type may include printer information. Printers, also, may be manufactured by various manufacturers. Instead of storing the manufacturers in the dimension tables, manufacturer IDs may be stored in the dimension tables. These manufacturer IDs may also be stored in an outrigger table in tuples. Each tuple may include the manufacturer ID and a manufacturer name.

An outrigger table like the one described above may speed and/or simplify obtaining information about manufacturers. For example, without the outrigger table, determining the distinct manufacturers may involve scanning each dimension table that includes manufacturer information, concatenating the manufacturers found, and eliminating duplicates. With the outrigger table, determining the distinct manufacturers may involve just scanning the outrigger table.

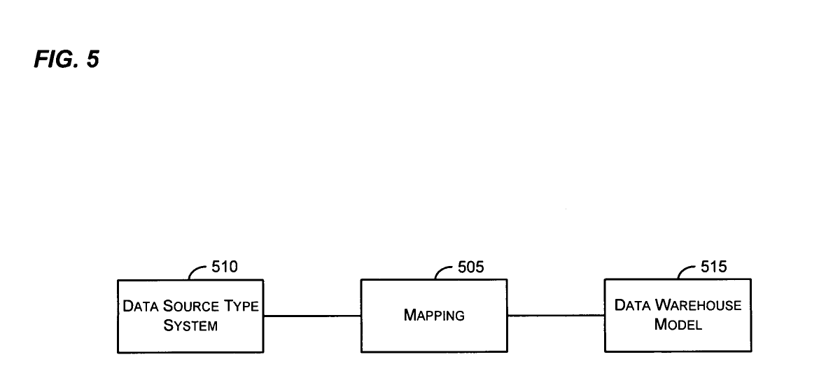

FIG. 5 is a block diagram that generally represents a mapping that associates elements of a type system with elements of a data warehouse model in accordance with aspects of the subject matter described herein. The mapping 505 may define associations between types of the data source type system 510 and elements of the data warehouse model 515, namely dimensions, facts, and outriggers.

Via the mapping 505, a dimension may be associated one-to-one with a type at any level in the type hierarchy. For example, referring to FIG. 3, a dimension may be associated with the computer type 311, with a client type 312, with a server type 313, or with any of the other types shown in the type system 305. The mapping may indicate whether all subtypes of a type are to be mapped to the same dimension. The mapping 505 may also indicate whether all properties in all subtypes of a mapped type are to be included in the dimension.

Via the mapping 505, a fact may be associated with a set of one or more types. Associating a fact with a type allows a fact table to be built which associates multiple dimensions in the data warehouse. Some exemplary XML that may be used to define an exemplary fact is as follows:

```
<Model>
  <Classes>
    <Entity abstract=“true”>
      <ID datatype=“integer” />
    </Entity>
    <Computer>
      <Parent>Entity</Parent>
      <Property datatype=“string”>Name</Property>
      <Property datatype=“string”>Manufacture</Property>
    </Computer>
    <User>
      <Parent>Entity</Parent>
      <Property datatype=“string”>Name</Property>
      <Property datatype=“string”>Email</Property>
    </User>
  </Classes>
  <Relationships>
    <Relationship>
      <Name>ComputerHasOwner</Name>
      <Source>Computer</Source>
      <Destination>User</Destination>
    </Relationship>
  </Relationships>
  <Facts>
    <Fact>
      <Name>ComputerUser</Name>
    <Relations>
      <Relation>ComputerHasOwner</Relation>
    </Relations>
    </Fact>
  </Facts>
</Model>
```

In the exemplary XML above, three types are defined: Entity, Computer, and User. A relationship (i.e., ComputerHasOwner) is defined that associates a computer with a user. Then, a fact (i.e., ComputerUser) is defined that includes the relationship (i.e. ComputerHasOwner) previously defined. Similarly, multiple types and relationships between those types may be defined. These relationships may then be used to create a fact that associates multiple dimensions in a data warehouse that are mapped to the types in the data source.

Via the mapping 505, an outrigger may be associated with properties of one or more types. The outrigger may then track name and ID of these properties across the one or more types. Some exemplary XML that may be used to define an exemplary outrigger is as follows:

```
<Model>
  <Classes>
    <Entity abstract=“true”>
      <ID datatype=“integer” />
    </Entity>
    <Computer>
      <Parent>Entity</Parent>
      <Property datatype=“string”>Name</Property>
      <Property datatype=“string”>Manufacture</Property>
    </Computer>
    <Printer>
      <Parent>Entity</Parent>
        <Property datatype=“string”>Name</Property>
        <Property datatype=“string”>Manufacture</Property>
    </Printer>
  </Classes>
  <Outriggers>
    <Outrigger>
      <Name>Manufacturer</Name>
      <Associations>
        <Association TypeName=“Computer”
          Property=“Manufacturer” />
        <Association TypeName=“Printer” Property=“Manufacturer”
          />
      </Associations>
    </Outrigger>
  </Outriggers>
</Model>
```

In the exemplary XML above, three types are defined: Entity, Computer, and Printer. Then, an outrigger is defined that associates the property Manufacturer that is included in the Computer and Printer types. Similarly, outriggers may be defined for a property of a certain type or for a set of similar properties from more than one type.

The definitions for the fact and the outriggers above may include more, less, and/or other types, properties, relationships, associations, and so forth without departing from the spirit or scope of aspects of the subject matter described herein. Furthermore, the form of the definitions for the fact and the outrigger is not limited to XML. For example, the definition may be included in a class hierarchy defined in a language other than XML. Indeed virtually any type definition language for the type system may be used without departing from the spirit or scope of aspects of the subject matter described herein. Based on the structure indicate above and the teachings herein, those skilled in the art may recognize many different type definition languages that may be used to define facts and outriggers without departing from the spirit or scope of aspects of the subject matter described herein.

The phrase “mapping information” refers to information in the mapping 505, data source type system 510, and/or data warehouse model 515. The mapping information may be utilized by one or more components that extract, transform, and load (ETL) data. These components may create and maintain a data warehouse modeled according to the data warehouse model 515 based on a data source structured according to the data source type system 510.

In particular, where the mapping 505 indicates that a type is associated with a dimension, a component may generate a storage element (e.g., a table) of the dimension such that the storage element has fields (e.g., columns) corresponding to the properties included in the type. If the type has subtypes, the component may add any additional properties included in the subtypes to the dimension if the mapping 505 indicates that this is to be done.

If a type system is updated, the component may update (e.g., keep in sync) the storage element of the dimension as appropriate. For example, if the mapping 505 indicates that subtypes are to be mapped to a dimension and that all properties are to be included, when a subtype of a mapped type is added to the type system, the dimension may be updated to include fields corresponding to properties of the subtype. Likewise, if a subtype of a mapped type is deleted, the dimension may be updated to remove fields for properties in the deleted subtype.

For extraction, a component may determine what data to extract from a data source based on the mapping information. For example, if the mapping 505 associates a type with a dimension and indicates that subtypes are not to be associated with the dimension, the component may extract data associated with the type but not extract data associated with subtypes of the type.

Likewise, for loading, a component may determine what data to load into a data warehouse based on the mapping information.

When the mapping information changes, the components above may operate to handle these changes. In one embodiment, a component may create code that does the work desired. For example, a component responsible for extracting data from a data source may generate code to extract the data from the data source. This code may remain until the component generates different code to extract the data.

As another example, a component responsible for maintaining a schema (e.g., table definitions) of a data warehouse, may generate code that maintains the schema. When based on the mapping information, the component determines that the schema of the data warehouse is to be changed, the component may replace the previously generated code with other code.

In another embodiment, the component itself may perform the work desired. For example, a component responsible for extracting data from a data source may change what data it extracts based on the mapping information. In this embodiment, the component may “interpret” the mapping information to determine how to extract data from a data source.

The mapping 505 may receive and store custom code to be used to generate a measure for a particular fact. A measure may not be included in any of the dimensions associated with a fact. For example, a measure of CPU utilization for a computer may not be in a computer dimension. To generate this measure, custom code may be created (e.g., by a developer) and provided to the mapping 505. The code may be stored in or associated with the mapping 505 and may then be subsequently used to generate the measure. It will be recognized that this mechanism allows measures to be calculated based on information outside of associated types in the type system.

In one example, the type system 305 of FIG. 3 may be defined via XML as follows:

```
<Classes>
  <Entity abstract=“true”>
    <ID datatype=“integer” />
  </Entity>
  <Computer>
    <Property datatype=“string”>Name</Property>
    <Property datatype=“string”>FQDN</Property>
  </Computer>
  <Server>
    <Parent>Computer</Parent>
    <Property datatype=“string”>SKU</Property>
    <Property datatype=“string”>HyperV</Property>
  </Server>
  <Client>
    <Parent>Computer</Parent>
    <Property datatype=“string”>Edition</Property>
  </Client>
  <WindowsXP>
    <Parent>Client</Parent>
    <Property datatype=“string”>IE7Compat</Property>
  </WindowsXP>
  <Vista>
    <Parent>Client</Parent>
    <Property datatype=“string”>Aero</Property>
    <Property datatype=“string”>SideBar</Property>
  </Vista>
  <Exchange>
    <Parent>Server</Parent>
    <Property datatype=”string”>Version</Property>
    <Property datatype=”string”>MailBoxes</Property>
  </Exchange>
  <SQL Server>
    <Parent>Server</Parent>
    <Property datatype=”string”>ConcurrentUsers</Property>
  </SQL Server>
</Classes>
```

The properties indicated above are exemplary and are not intended to be all-inclusive or exhaustive. In an actual type system, there may be many other properties defined in the type system. Furthermore, the form of the definition of the type system is not limited to XML. For example, the definition may be included in a class hierarchy defined in a language other than XML. Indeed virtually any type definition language for the type system may be used without departing from the spirit or scope of aspects of the subject matter described herein. Based on the structure indicate above and the teachings herein, those skilled in the art will recognize many different type definition languages that may be used to define a type system of a data source without departing from the spirit or scope of aspects of the subject matter described herein.

If an administrator desires to create a data warehouse with two dimensions and associate the dimensions with the type system above, the administrator may use the exemplary XML below:

```
<Dimensions>
  <ComputerDim>
    <ClassAssociation>Computer</ClassAssociation>
    <IncludeSubClasses>Yes</IncludeSubClasses>
    <IncludeAllProperties>Yes</IncludeAllProperties>
  </ComputerDim>
  <ServerDim>
    <ClassAssociation>Server</ClassAssociation>
    <IncludeSubClasses>No</IncludeSubClasses>
    <IncludeAllProperties>Yes</IncludeAllProperties>
  </ServerDim>
</Dimensions>
```

In the XML above, a computer dimension and a server dimension are defined. The computer dimension is associated with the computer type of the previous type system. The computer dimension indicates that subtypes are to be included in the dimension and also indicates that all properties found in all subtypes are to be included.

The server dimension is associated with the server of the previous type system. The server dimension is not to include subtypes of the server type, but is to include all of the properties of the server type.

The two XML snippets above may be associated together by placing them in the same XML document and/or between tags. For example, the two XML snippets above may be placed between tags as follows:

```
<Model>
  Type system XML placed here
  Dimension XML placed here
</Model>
```

The mapping information may also allow additional interaction between a data source and the data warehouse. For example, using the mapping information, a user viewing the data source may obtain information about a measure for type of the data source. The measure may have been created after the type, but with the mapping information, a data source component may determine that additional information (e.g., a measure) is available and may present a user interface to allow the user to determine what additional information (e.g., what measures) is available and also allow the user to view the additional information.

Furthermore, a user viewing data in the data warehouse may be able to “drill down” into information contained therein and access information from one or more data sources associated with the data warehouse via the mapping information. For example, a user may be viewing a report presented by a component of the data warehouse and may be able to double click (or provide other input) on an employee ID displayed in the report. When the user drills down, the data warehouse may use the mapping information to provide access to the data and/or may open an interface (e.g., a form) that allows the user to directly access the data in the appropriate data source(s).

Reports generated at the data warehouse may be written such that they surface or do not surface new properties included in new subtypes. For example, a report may be written such that it is using a known set of types and properties. This report may maintain its format even if the type, its properties, or the hierarchy are changed.

If a report is authored in a way to anticipate and take advantage of new properties and/or new derivations to be made to existing types, when new properties and/or new derivations are made, the report may automatically allow displaying of the new information as desired.

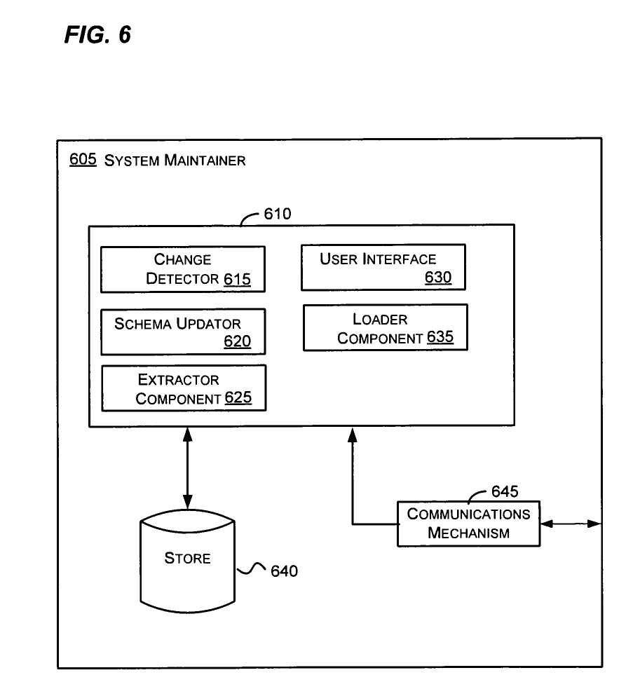

FIG. 6 is a block diagram that represents components of an exemplary system configured in accordance with aspects of the subject matter described herein. The components illustrated in FIG. 6 are exemplary and are not meant to be all-inclusive of components that may be needed or included. In other embodiments, the components and/or functions described in conjunction with FIG. 6 may be included in other components (shown or not shown) or placed in subcomponents without departing from the spirit or scope of aspects of the subject matter described herein. In some embodiments, the components and/or functions described in conjunction with FIG. 6 may be distributed across multiple devices (e.g., the devices illustrated in FIG. 6).

Turning to FIG. 6, the system maintainer 605 may include data components 610, a store 640, and a communications mechanism 645. The data components 610 may include a change detector 615, a schema updator 620, an extractor component 625, a user interface 630, and a loader component 635.

The communications mechanism 645 allows apparatus(es) upon which the system maintainer 605 is hosted to communicate with other entities as shown in FIG. 2. The communications mechanism 645 may be a network interface or adapter 170, modem 172, or any other mechanism for establishing communications as described in conjunction with FIG. 1.

The store 640 is any storage media capable of storing mapping information. The store 640 may comprise a file system, database, volatile memory such as RAM, other storage, some combination of the above, and the like and may be distributed across multiple devices. The store 640 may be external, internal, or include components that are both internal and external to the apparatus(es) hosting the system maintainer 605.

The change detector 615 comprises one or more processes, threads, or the like that are responsible for detecting changes to a data type and/or data on a data store. In response to a change to a data type, the change detector 615 may determine if the change affects a data warehouse. A change may affect the data warehouse if, for example, the change modifies a type or a subtype that is mapped to a dimension, fact, or outrigger. If a change affects the data warehouse, the change detector 615 may trigger the schema updator 620, the extractor component 625, and the loader component 635.

The schema updator 620 may comprise a component that is responsible for updating and/or creating the schema of a data warehouse based on mapping information. For example, the mapping information may indicate types that are associated with dimensions. Using this information, the schema updator 620 may create dimensions having fields (e.g., columns) suitable for storing information from a data source structured according to the types.

The extractor component 625 may comprise a component that is responsible for extracting data from a data source and providing that data to a loader. The extractor component 625 may utilize the mapping information to determine the data that needs to be extracted from a data source. Using the mapping information, the extractor component 625 may generate code that extracts the data from the data source.

The user interface 630 may comprise a component that interfaces with a system administrator or the like to obtain the mapping information. For example, the user interface may 630 may provide a graphical interface in which an administrator may enter associations between elements of a data warehouse (e.g., dimensions, facts, and outriggers) and types of a type system. The interface may also allow an administrator to indicate code usable to generate a measure associated with a fact.

The loader component 635 may comprise a component that is responsible for loading extracted data into a data warehouse. The loader component 635 may utilize the mapping information to determine the data that needs to be loaded into the data warehouse. Using the mapping information, the loader component 635 may generate code that loads the data into the data warehouse.

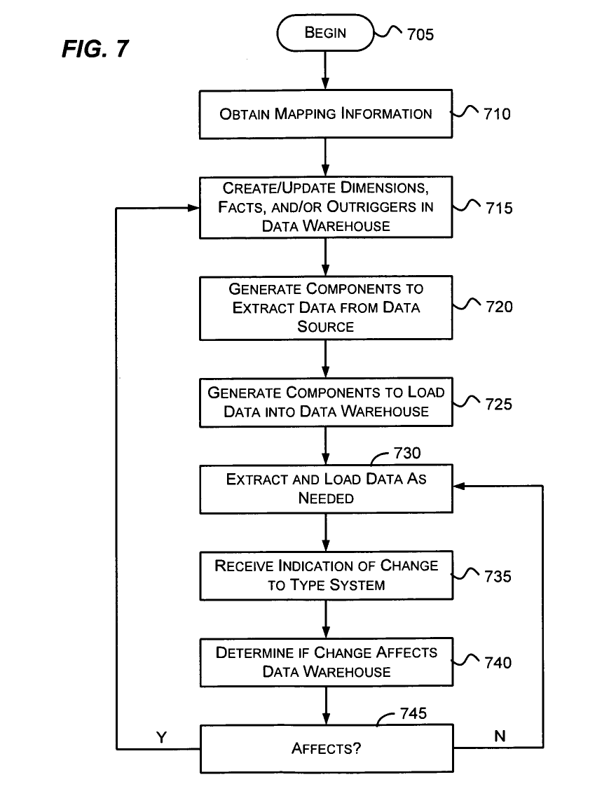

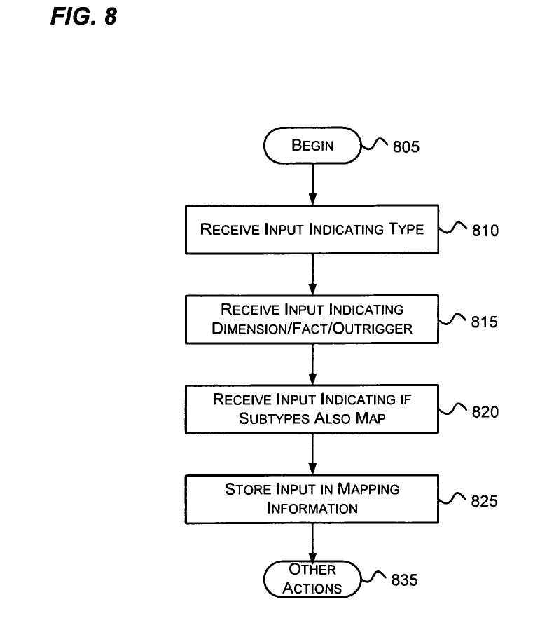

FIGS. 7-8 are flow diagrams that generally represent actions that may occur in accordance with aspects of the subject matter described herein. For simplicity of explanation, the methodology described in conjunction with FIGS. 7-8 is depicted and described as a series of acts. It is to be understood and appreciated that aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methodology in accordance with aspects of the subject matter described herein. In addition, those skilled in the art will understand and appreciate that the methodology could alternatively be represented as a series of interrelated states via a state diagram or as events.

FIG. 7 is a flow diagram that generally represents exemplary actions that may occur to obtain data from various data sources in accordance with aspects of the subject matter described herein. Turning to FIG. 7, at block 705, the actions begin. At block 710, mapping information is obtained. For example, referring to FIGS. 5 and 6, the schema updator 620 may obtain mapping information included in FIG. 5. This mapping information may include a type system, elements of a data warehouse model (e.g., dimensions, facts, and outriggers), and a mapping between types in the type system and elements of the warehouse model.

At block 715, elements of the data warehouse schema are created/updated. For example, referring to FIG. 6, the schema updator 620 may use mapping information to generate tables corresponding to dimensions, facts, and outriggers.

At block 720, components to extract data from the data source are generated. For example, referring to FIG. 6, the extractor component 625 may generate code to extract data identified by the mapping information to be loaded into the data warehouse.

At block 725, components to load data into the data warehouse are generated. For example, referring to FIG. 6, the loader component 635 may generate code to load data into the data warehouse. This code may be generated using the mapping information.

At block 730, data is extracted and loaded as needed. For example, referring to FIG. 2, warehouse agents 225-230 may extract data from their respective data sources while the data collector 220 may load this data into the data warehouse 205.

At block 735, an indication that the type system has changed is received. For example, referring to FIG. 6, the change detector 615 may detect (e.g., by actively looking or being informed) that a change has occurred to a type system.

At block 740, a determination is made as to whether the change affects the data warehouse. For example, referring to FIG. 3, the subtype vista 314 may be added to the type system 305. If the computer type 311 and its subtypes are mapped to a dimension, when the subtype vista 314 is added, this is a change that affects the data warehouse.

At block 745, if the change affects the data warehouse, the actions continue at block 715; otherwise, the actions continue at block 730. If the change affects the data warehouse, then elements of the data warehouse may be updated to accommodate the change. If the change does not affect the data warehouse, the normal process of extracting and loading data may continue.

FIG. 8 is a flow diagram that generally represents actions that may occur in receiving and creating mapping information in according with aspects of the subject matter described herein. Turning to FIG. 8 at block 805, the actions begin.

At block 810, first input is received that indicates a type of a type system. For example, referring to FIG. 6, a user interface 630 may receive input that indicates a type system. As another example, a type system may be indicated via an XML or other file.

At block 815, second input is received that indicates an element (e.g., dimension, fact, outrigger) of a data warehouse to associate with the type. For example, referring to FIG. 6, the user interface 630 may receive input that indicates an element to associate with the type. As another example, this may be indicated via an XML or other file.

At block 820, third input is received that indicates whether subtypes are also to map to the element. For example, referring to FIG. 6, the user interface 630 may receive an indication (e.g., a check box) that indicates whether subtypes are also to map to the element. As another example, this may also be indicated via an XML or other file.

At block 835, other actions, if any, may occur.

As can be seen from the foregoing detailed description, aspects have been described related data warehousing. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A method implemented at least in part by a computer, the method comprising:
obtaining mapping information that includes a type system, a dimension, and a mapping that associates a type within the type system to the dimension, the type system associated with a data source that stores data as defined by the type system, the type system indicating a hierarchy of types, the dimension associated with a data warehouse, the mapping indicating at least whether data associated with subtypes of the type is to be copied from the data source to the data warehouse;
based at least on the mapping information, automatically maintaining the dimension and a system that extracts data from the data source and provides the data to the data warehouse.

2. The method of claim 1, wherein automatically maintaining the dimension and a system that extracts data from the data source and provides the data to the data warehouse comprises determining that a change associated with the type has occurred, and in response, updating the dimension and the system to accommodate the change.

3. The method of claim 2, wherein the change comprises an addition of a property to the type and wherein updating the dimension and the system to accommodate the change comprises changing the dimension to include a field corresponding to the property and changing the system to extract the property and provide the property to the dimension.

4. The method of claim 2, wherein the change comprises an addition of a subtype to the type and wherein updating the dimension and the system to accommodate the change comprises changing the dimension to include fields corresponding to properties of the subtype and changing the system to extract the properties and provide the properties to the dimension.

5. The method of claim 1, wherein automatically maintaining the dimension and a system that extracts data from the data source and provides the data to the data warehouse comprises generating code that creates the dimension based on properties of the type and subtypes of the type, if any.

6. The method of claim 1, wherein automatically maintaining the dimension and a system that extracts data from the data source and provides the data to the data warehouse comprises generating code that extracts data of the type and subtypes of the type from the data source.

7. The method of claim 1, wherein the dimension comprises a table with columns and wherein automatically maintaining the dimension and a system that extracts data from the data source and provides the data to the data warehouse comprises keeping the columns in sync with properties of the type and subtypes of the type, if any, such that each column of the dimension corresponds to a property of the type or one of the subtypes, if any.

8. The method of claim 1, wherein the mapping information further includes code usable to obtain a measure associated with a fact of the data warehouse, the fact associating two or more dimensions together.

9. The method of claim 1, further comprising based at least on the mapping information, automatically maintaining a fact that associates multiple dimensions of the data warehouse and automatically maintaining an outrigger associated with one or more types of the type system.

10. A computer storage medium having computer-executable instructions, which when executed perform actions, comprising:
receiving an indication of a change to a type system associated with a data source, the type system indicating a hierarchy of types of data;
based at least in part on a mapping, determining whether a data warehouse is affected by the change, the mapping associating a dimension in the data warehouse to at least one type of the type system, the mapping indicating whether data associated with subtypes, if any, of the at least one type is to be represented in the dimension; and
if the data warehouse is affected, updating the data warehouse to be capable to receive information associated with the change and updating a system that obtains the information from the data source and provides the information to the data warehouse.

11. The computer storage medium of claim 10, wherein the change comprises an addition, deletion, or modification of a subtype to the type.

12. The computer storage medium of claim 10, wherein the change comprises a modification to the type, the modification adding, renaming, or deleting properties included in the type.

13. The computer storage medium of claim 10, wherein the data warehouse is affected if the change changes the at least one type of the type system.

14. The computer storage medium of claim 10, wherein the data warehouse is affected if the change adds, deletes, or modifies a subtype of the at least one type and the mapping indicates that data associated with the subtypes is to be represented in the dimension.

15. The computer storage medium of claim 10, wherein updating the data warehouse to be capable to receive information associated with the change comprises adding one or more fields to the dimension, the one or more fields corresponding to properties added by the change.

16. The computer storage medium of claim 10, wherein updating a system that obtains the information from the data source and provides the information to the data warehouse comprises generating first code that obtains the information from the data source and second code that copies the information to the data warehouse, the first code extracting data from the type and subtypes, if any, if indicated by the mapping.

17. A method implemented at least in part by a computer, the method comprising:
receiving first input that indicates a type of a type system, the type system defining data stored on a data source
receiving second input that indicates a dimension of a warehouse that is to be associated with data of the type, the dimension to be stored on a data warehouse;
receiving third input that indicates whether data associated with subtypes, if any, of the type is to be copied from the data source to the data warehouse; and
storing data derived from the first, second, and third inputs in mapping information, the mapping information indicating the type, the dimension, and whether data associated with subtypes, if any, of the type is to be copied from the data source to the data warehouse.

18. The method of claim 17, further comprising:
receiving fourth input at a user interface of a component associated with the data source; and
in response to the fourth input, using at least the mapping information to provide a measure from a fact of the data warehouse, the measure indicating additional information about data included in the data source.

19. The method of claim 17, further comprising:
receiving fifth input that indicates a type of the type system that is to be associated with an outrigger of the data warehouse, the outrigger including tuples, each tuple including an identifier and a name associated with the identifier, the outrigger associated with one or more dimensions via identifiers in the tuples, and
storing data derived from the fifth input in the mapping information.

20. The method of claim 17, further comprising:
receiving fourth input from a user interface associated with the data warehouse, the fourth input requesting access to information from the data source; and
using at least the mapping information to access the information from the data source.
